(19) United States
(12) Patent Application Publication
(10) Pub. No.: US 2024/0177541 A1
(43) Pub. Date: May 30, 2024

(54) ADAPTIVE TRAINING OF DATA DRIVEN ANALYSIS TO CHARACTERIZE FAULTS IN PHYSICAL SYSTEMS

(71) Applicant: Raise a Hood, Inc., Deephaven, MN (US)

(72) Inventor: Patrick Nunally, San Diego, CA (US)

(21) Appl. No.: 18/520,270

(22) Filed: Nov. 27, 2023

Related U.S. Application Data
(60) Provisional application No. 63/385,167, filed on Nov. 28, 2022.

(51) Int. Cl. G07C 5/08; G06Q 10/20; G06V 10/44; G07C 5/00

(52) U.S. Cl. CPC G07C 5/0808; G06Q 10/20; G06V 10/44; G07C 5/008

(57) ABSTRACT

Examples provide for training and optimization of an apparatus to affect the diagnosing, repairing and prediction of systems, sub-systems, assemblies and/or component failures of physical systems, according to an adaptively weighted hierarchy of processes. The examples can be directed to the optimizing systems for computing the probability of conditions causing a system failure, based in part on currently observed physical system behavior, apriori knowledge of the physical system's structure and spatiotemporal behavior of a constellation of like physical systems. Resultant training via said systems and methods yields the probabilities causing a system failure including secondary stress or efficiency determinations resulting from a primary system, sub-systems, assemblies and/or component failures within physical systems. Training information of the systems and methods is obtained from one or more repair invoice data scans, reported indicators of system operation or previously derived weighting structures used to refine the confirmed-solution classifier.

### BACKGROUND

### Field of the Disclosure

The present disclosure relates to the field of servicing or repairing physical systems. More particularly, the disclosure relates to systems and methods for training and optimization of an apparatus to affect the diagnosing and classification of systems that are operating outside of a previously defined set of operational parameters.

### Background of the Disclosure

Troubleshooting is the process of diagnosing and repairing a system that is behaving abnormally. Diagnostic and repair actions may incur costs, and traditional troubleshooting procedures are directed to minimize the costs incurred until the system is repaired.

System failures are prevalent in practically all the engineering fields, including but not limited to automobiles, robots, appliances, information, and computational systems. As systems become more complex, failures often become more common and maintenance costs tend to increase. As a result, automated diagnosis has been studied in the artificial intelligence field for several decades, with substantial progress and successful applications in space crafts, satellite decision support systems, automotive industry, and spreadsheets. The output of the diagnosis procedures is a set of possible diagnoses, where each possible diagnosis is an explanation of the observed system failure. Model-based diagnosis is a common approach for diagnosis that uses a model of the diagnosed system to infer diagnoses explaining the observed system failure.

Diagnosis, and in particular root-cause analysis (where a root cause is the set of elements faults or conditions of use are diagnosed system as the one or more causes of the system's abnormal operation or failure), is the task of understanding what has happened in the past that has caused an observed failure. Prognosis is the task of predicting what will happen in the future, and when future failures will probabilistically occur.

Prognosis techniques have been developed for estimating the remaining useful life of components in a system. In particular, survival analysis is a sub-field of statistics, in which various methods have been developed to generate survival curves of components, which are curves that plot the likelihood of a component to survive (not to fail) as a function of the components usage or age.

Conventional automated troubleshooting techniques are based on “Decision Theoretic Troubleshooting (DTT)”, Heckerman et al., Communications of the ACM, 38(3):49-57, 1995. This decision theoretic approach combines planning and diagnosis, and was applied to a troubleshooting application where a sequence of actions may be needed to perform repairs. For example, a vehicle may need to be disassembled to gain access to its internal parts. To address this problem, prior solutions used a Bayesian network for diagnosis and the AO* algorithm (described in “Principles of artificial intelligence”, Nils J Nilsson, Springer, 1982) as the planner. Another solution is using abstractions to improve the efficiency of troubleshooting. Other techniques propose a troubleshooting algorithm aimed at minimizing the breakdown costs, a concept that corresponds roughly to a penalty incurred for every faulty output in the system and for every time step until the system is fixed.

### SUMMARY

In general terms, this disclosure is directed to adaptive training of data driven analysis to characterize faults in physical systems.

A first aspect of this disclosure is directed to a system and method to adaptively augment the ability of apparatus diagnoses of systems, sub-systems, assemblies and/or component failures of physical systems by the system and method described herein of fusing in the training in part on observed physical system behavior, apriori knowledge of the physical system's structure and spatiotemporal behavior of a constellation of like physical systems.

A second aspect of this disclosure is directed to a system and method to adaptively augment the ability of apparatus predictive diagnoses of systems, sub-systems, assemblies and/or component failures of physical systems by the system and method described herein of fusing in the training in part on observed physical system behavior, apriori knowledge of the physical system's structure and spatiotemporal behavior of a constellation of like physical systems.

It is an aspect of the present disclosure to provide a systems and method for training and optimization of an apparatus to effect the diagnosing, repairing and prediction of systems, sub-systems, assemblies and/or component failures of physical systems, according to an adaptively weighted hierarchy of processes for improving decision making for fixing a current fault, while considering also future faults.

It is another aspect of the present disclosure to provide a systems and method for training and optimization of an apparatus to affect the diagnosing, repairing and prediction of systems, sub-systems, assemblies and/or component failures of physical systems, according to an adaptively weighted hierarchy of processes for choosing which action to perform, for fixing system faults.

Other advantages of the present disclosure will become apparent as the description proceeds.

In one or more illustrative examples, systems and methods for affinity linked expert-in-the-loop information for training data construction is provided. Training data is uniquely constructed by indexing sourcing parameters to ensure shared relevance and then establishing affinity links within subsampled data hence modifying data prior to integration into larger training/test datasets where these affinity links are established by the method of the said system based on one or more autoregressive models to establish affinity metrics between data elements prior to those elements inspiration into training of deep learning algorithms. The inclusion of affinity metrics into raw data in training datasets results in significantly greater convergence of large-scale classification algorithms as the affinity sample relevance and weighting metrics of indeterminate solutions using limited inter data classification of confirmed solutions.

In one or more illustrative examples, a system for establishing affinity links within co-sampled data is provided. The system includes a computing platform including a hardware processor. The processor is programmed to determine affinity weighting metrics of indeterminate solutions to a repair problem represented in co-sampled data according to relevance and likelihood of containing confirmed solutions using an indeterminate-solution classifier; and provide the interrelated data for system analysis to find and extract confirmed affinity metrics.

In one or more illustrative examples, a non-transitory computer readable medium including instructions for establishing affinity links within co-sampled data is provided. The system includes a computing platform including a hardware processor. The processor is programmed to determine affinity weighting metrics of indeterminate solutions to a repair problem represented in co-sampled data according to relevance and likelihood of containing confirmed solutions using an indeterminate-solution classifier; and provide the interrelated data for system analysis to find and extract confirmed affinity metrics.

Another aspect of the disclosure is directed to a diagnostic system. The system comprises one or more remote sources of machine learning training data. The system further comprises one or more hardware computing devices implementing the diagnostic system that constructs a probabilistic affinity mapping between a first and a second dataset of the machine learning training data, which, when linked, comprises a plurality of historical queries and historical commands test-sampled from one or more production logs of a deployed dialogue system. The one or more hardware computing devices further configures one or more training data sourcing parameters to source one of the first and second dataset of the machine learning training data from the one or more remote sources of the machine learning training data. The one or more hardware computing devices further transmits the one or more training data sourcing parameters to the one or more remote sources of the machine learning training data. The one or more hardware computing devices further collects the one of the first and second dataset of the machine learning training data. The one or more hardware computing devices further calculates one or more validation metrics of the one of the first and second dataset of machine learning training data, including calculating one or more of a coverage metric value and a diversity metric value of the machine learning training data. The one or more hardware computing devices further identifies whether to train at least one machine learning classifier based on one or more of the coverage metric value and the diversity metric value of the machine learning training data. The one or more hardware computing devices further uses the machine learning training data as machine learning training input, to train the at least one machine learning classifier when the coverage metric value of the machine learning training data satisfies a minimum coverage metric value threshold. The one or more hardware computing devices further, responsive to training the at least one machine learning classifier using the machine learning training data, deploys the at least one machine learning classifier to intake users' requests and provide relevant diagnostic analysis.

Another aspect of the disclosure is directed to a method. The method comprises constructing an affinity linked machine learning training dataset comprising a plurality of historical queries and historical commands test sampled from one or more production logs of a deployed diagnostic system. The method further comprises configuring one or more training data sourcing parameters to source the affinity linked machine learning training dataset from one or more remote sources of indication and action data. The method further comprises transmitting the one or more training data sourcing parameters to one or more remote sources of machine learning training data and collecting the affinity linked machine learning training dataset. The method further comprises calculating one or more validation metrics of the affinity linked machine learning training dataset, wherein calculating the one or more validation metrics includes calculating one or more of a coverage metric value and a diversity metric value of the affinity linked machine learning training dataset. The method further comprises identifying whether to train at least one machine learning classifier of the artificially intelligent diagnostic system based on one or more of the coverage metric value and the diversity metric value of the affinity linked machine learning training dataset. The method further comprises using the affinity linked machine learning training dataset to train the at least one machine learning classifier if the coverage metric value satisfies a minimum coverage metric threshold. The method further comprises responsive to training the at least one machine learning classifier, deploying the at least one machine learning classifier into an online implementation of an artificially intelligent diagnostic system.

Another aspect of the disclosure is directed to a method of creating affinity linked training data. The method comprises capturing data comprising one or more data or image files to provide a delimited dataset. The method further comprises extracting one or more contextual tags from the one or more data or image files of the delimited dataset. The method further comprises indexing the one or more data or image files of the delimited dataset by the one or more contextual tags. The method further comprises partitioning the one or more data or image files of the delimited dataset into ingress data and egress data. The method further comprises performing action recognition processing on the egress data. The method further comprises performing indication recognition processing on the ingress data. The method further comprises generating a first data structure and second data structure of interleaved data. The method further comprises unifying the first data structure and the second data structure into a training set for one or more processing models.

### BRIEF DESCRIPTION OF THE DRAWINGS

FIG. 1 illustrates a flow chart of a process for establishing affinity links within co-sampled data for incorporation into training datasets of one or more autoregressive models.

FIG. 2 illustrates an example system for processing data using affinity linked co-sampled training datasets in one or more autoregressive models.

FIG. 3 illustrates an example of operational data flow of affinity metrics determination with co-sampled data to be used as training and test data.

FIG. 4 illustrates an example computing device for use in the multi-dimensional creation of affinity linked training data with co-sampled data to be used as training and test data.

FIG. 5 illustrates an example system for processing of multi-dimensional affinity linked training with co-sampled data gathered from experts, users, devices and stakeholders.

FIG. 6 illustrates an example training system for an adaptive filter.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

One or more implementations of the present disclosure provide an adaptive system, method and apparatus for training one or more adaptive filters in whole or in part via affinity linked data representing observed physical system behavior, apriori knowledge of the physical system's structure and spatiotemporal behavior of a constellation of like physical systems, historical queries made in light of the physical system, historical commands provided to like systems, as well as test-data sampled from one or more production logs of a deployed dialogue systems operating with like physical systems.
presented repair actions or parts, inclusive of integrated costs minimization and anticipation of current or future failures.

One or more implementations of the present disclosure provide a system, method, and apparatus, to resolve problems in the existing technology, specifically one such problem includes the recurrent divergence of large-scale classification algorithms caused when disparate training data are used in training of adaptive filters.

The following technical solutions used in the implementation of the present disclosure function in sharp contrast to training data used in the prior art which principally rely on a large number of tagged training/test samples. The present disclosure includes systems methods and apparatus that employ affinity linking technology in a unique way resulting in unexpected and highly desirable results.

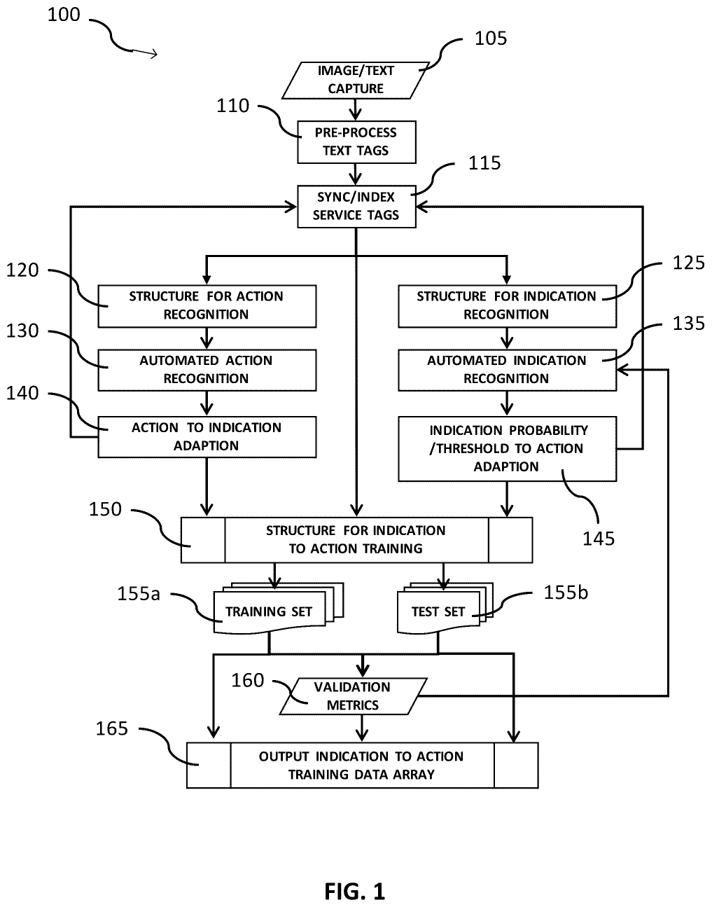

As illustrated in FIG. 1 the present disclosure includes a decentralized system, method and apparatus. In some examples, the decentralized system is configured to perform a method 100 of creating affinity linked training data. In some examples, the method includes operations 105, 110, 115, 120, 125, 130, 140, 145, 150, 160, and 165.

In some examples, operation 105 includes capturing image and/or text data. In some examples, operation 105 further includes providing a delimited dataset captured as one or more data or image files and normalized in perspective, size, contrast, and rotation.

In some examples, operation 110 includes pre-processing text tags. In some examples, depending on the type of data input, operation 110 includes optical character recognition applied to image data prior to natural language processing processes used to extract contextual tags to label information. In some examples, label information can include, but is not limited to, personal information, shop information, service issues, OBDII codes, service reports, diagnosis, service, labor, parts, pricing, warranty, and conditions.

In some examples, operation 115 includes syncing and/or indexing service tags. In some examples, in operation 115, processed data from operation 110 is subsequently indexed using a recursive framework assigning template index indicators to data (tracking linked or database linked) starting with an apriori template for adaptation in the systems or methods herein.

In some examples, indexed data from operation 115 is provided for a plurality of processes comprising, for example, operations 120, 125, and 150. In some examples, operation 120 comprises structuring of data for action recognition; operation 125 comprises structuring of data for indication recognition; and operation 150 comprises conditionally structuring for indication to action training. In some examples, indexed data further undergoes the process of structuring synchronization and indexing for ingress and egress data recognition. To be specific, in some examples, parallel processes are initiated on the indexed data from operation 115 including processes to normalize information for processing egress information for action recognition (in operation 120) as well as a separate process of normalization of ingress information for processing indication recognition (in operation 125).

Upon completion of operations 105, 110, 115, 120, and 125, ingress and egress information has been on-boarded into the system (in operation 105) labeled (in operation 110), indexed for synchronization and applied with templates (in operation 115), and partitioned into separate processes for egress data processing for action recognition (in operation 120) and for ingress data processing for indication recognition (in operation 125). In some examples, after the egress data is structured for action recognition in operation 120, the processed data is delivered for provisional classification processing of structured ingress data in operation 130 based on local optimization of the active weighting states of the adaptive template data from operation 115. In some examples, operation 130 includes automated action recognition. In parallel to the provisional classification process of structured egress data in operation 130, ingress data processed in operation 125 is delivered to a provisional classification process of structured ingress data in operation 135 based on local optimization of the active weighting states of said adaptive template data from operation 115. In some examples, operation 135 includes automated indication recognition.

Once provisionally classified, the structured egress data from operation 130 and ingress data from operation 135 enter separate but parallel adaptive processes in operations 140 and 145, respectively. In operation 140, an automated indication adaption is affected in an optimization process which, in some examples, includes data refinement following a stochastic gradient descent to incrementally change the template weights to minimize a loss function defined by the apriori or previous correlation vector set or service tags from operation 115. In a separate, but parallel process, in operation 145, automated indication to action adaption is affected in an optimization process which, in one embodiment, includes data refinement following a stochastic gradient descent to incrementally change the template weights to minimize a loss function defined by the apriori or previous correlation vector set with a fixed local optimization goal from operation 115.

Once ingress and egress data have been synchronized, indexed, classified, and optimized, the resultant affinity metrics have been loaded from their respective processes in operations 145 and 140 back into the synchronization and indexing process of operation 115 to measure, in some embodiments, against an adaptive tagging threshold. Once data has crossed at least one correlation threshold and the synchronization and indexing process of operation 115 to measure, in some embodiments, against an adaptive tagging threshold passes resultant affinity metrics, indication data and action data move into a process which constructs optimized sets of weights gathered from the action to indication adaption, in operation 140, and indication probability/threshold to action adaption, in operation 145, as well as probabilistic affinity metrics for each of a plurality of indication to action data representations and a plurality of action to indication data representations within the machine learning training data drawn from sync/index service tags, in operation 115. In some examples, This plurality of distinct affinity linked datasets is constructed using a plurality of engineered queries and/or engineered commands. In some examples, each of the plurality of engineered queries and/or engineered commands is artificially generated for one or more identified request classification tasks. In some examples, this yields two data separate data structures 155a, 155b of interleaved data. Functionally the two resultant data structures 155a, 155b are similar in nature but not in content and differ principally in how they will be used in validation metrics in operation 160. In some examples, a calculated coverage metric value and diversity metric value are included as qualifiers of metes and bounds of the larger dataset for a given vehicle under test where said coverage metrics are used in calculation of a minimum coverage metric threshold to gauge confidence in the validity of results so that data which presents as sparce will not corrupt the validity of learning or outcomes.

A following process, in operation 160, locally validates the predictive sufficiently of the resultant data where such efficiently can be affected by the choice of apriori initialization. This process basically is validating convergence and altering structure for indication recognition from operation 125 to filter residual instability if the resultant training data encounters inner numerical difficulties. Data in the form of validation indication is produced in operation 160. In some embodiments, the two data structures 155a, 155b comprise a training dataset 155a and test dataset 155b which are unified into a training set 165 for one or more processing models selected from a group comprising modular, feedforward, radial basis function, Kohonen self-organizing, recurrent, group method of data handling, autoencoder, probabilistic, time delay, convolutional, deep stacking network, regulatory feedback, general regression, deep belief network, fully recurrent, simple recurrent, reservoir computing, long short-term memory, bi-directional, hierarchical, stochastic, genetic scale, committee of machines, associative, physical, instantaneously trained, spiking, neocognitron, compound hierarchical-deep models, deep predictive coding networks, multilayer kernel machine, dynamic, cascading, neuro-fuzzy, compositional pattern-producing, memory networks, one-shot associative memory, hierarchical temporal memory, holographic associative memory, LSTM-related differentiable memory structures, neural Turing machines, semantic hashing, pointer networks, and hybrids of any of this set.

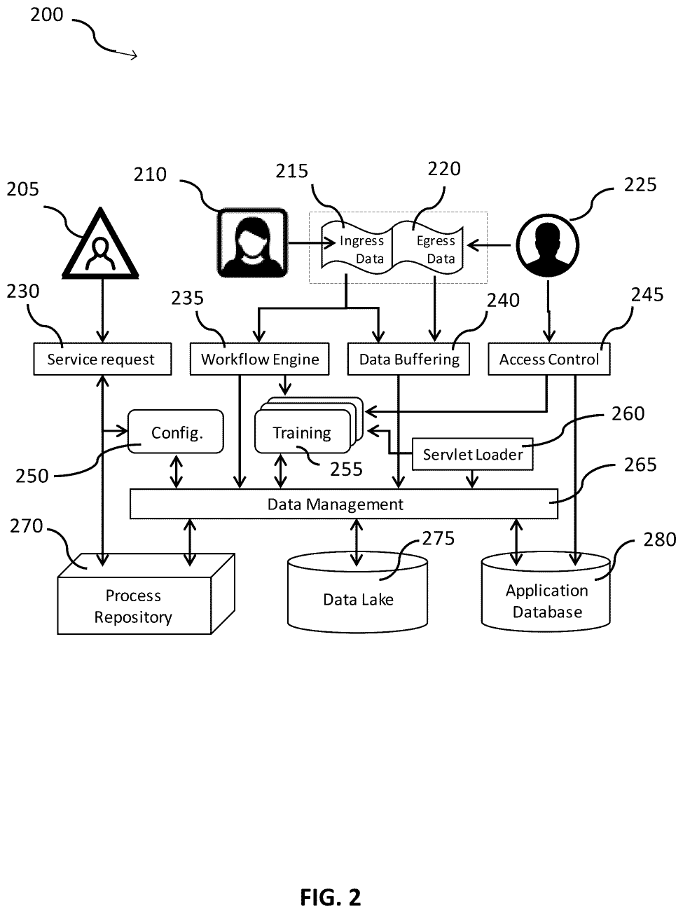

An example application environment 200 of the technology disclosed herein is illustrated in FIG. 2. The application environment 200 can be implemented using one or more computing devices. In this embodiment an indication data provider 210 supplies ingress data 215 and an action data provider 225 supplies egress data 220 in response to said ingress data 215 as a result of actions taken by action data provider 225. When said action data provider 225 supplies a request for incorporation a workflow engine 235 and a data buffer 240 of ingress data 215 and egress data 220, respectively. In this embodiment the workflow engine 235 selectively triggers training 255 as requested by the access control 245, managed by a training servelet loader 260 allowing the data management system 265 to update data dependances governed by the process repository 270, stored in the data lake 275 and referenced by the application database 280. When the servlet loader 260 determines that the training of the system using the ingress data 215, egress data 220 and the affinity data synthesized in the workflow engine 235 is optimized in the data lake 275 operational control is transitioned to the configuration controller 250 making the data management system 265 ready to process a service request 230 in response to a service data provider 205.

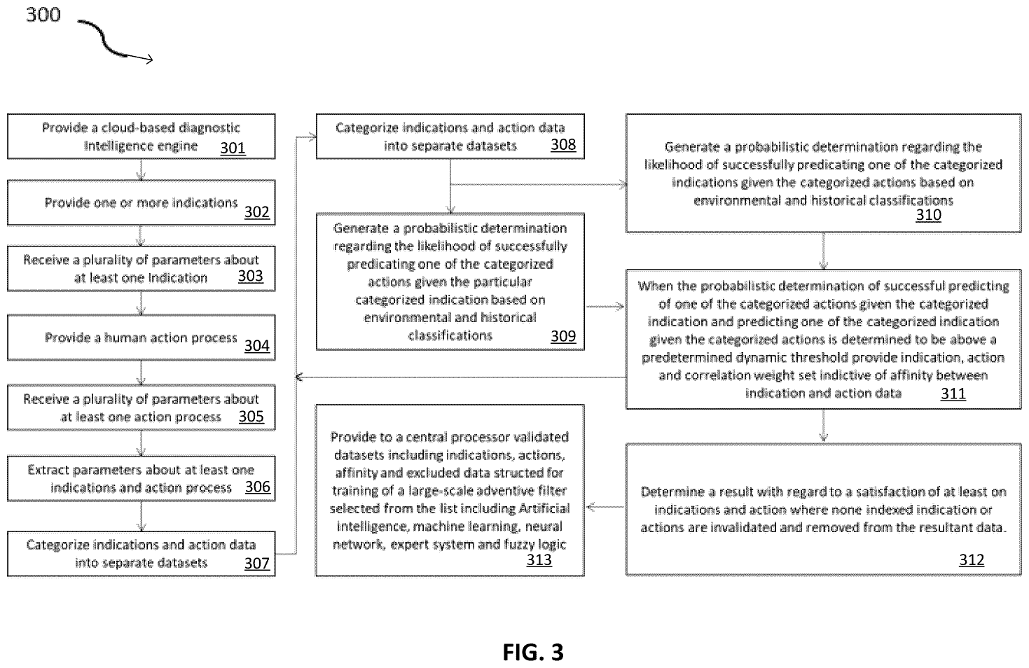

The operational data flow 300 of a training system used in some embodiments of an application environment 200 is illustrated in FIG. 3. In some examples, the operational data flow includes operations 301, 302, 303, 304, 305, 306, 307, 308, 309, 310, 311, 312, and 313.

In operation 301 the training system provides a cloud-based diagnostic intelligence engine.

In operation 302 the training system provides one or more indications in the form of a common identity of device under analysis.

In operation 303 the training system receives a plurality of parameters about at least one indication of operation.

In operation 304, the training system provides a human action process at least one anomaly of operation.

In operation 305, the training system receives a plurality of parameters about at least one action process.

In operation 306, the training system extracts parameters about at least one indications and action process.

In operation 307, the training system categorizes indications and action data into separate datasets.

In operation 308, the training system categorizes indications and action data into separate datasets.

In operation 309, the training system generates a probabilistic determination regarding the likelihood of successfully predicating one of the categorized actions given the particular categorized indication based on environmental and historical classifications of queries, commands, production logs, and dialogue system data.

In operation 310, the training system generates a probabilistic determination regarding the likelihood of successfully predicating one of the categorized indications given the categorized actions based on environmental and historical classifications.

In operation 311, when the probabilistic determination of successful predicating of one of the categorized actions given the categorized indication and predicating one of the categorized indications given the categorized actions is determined to be above a predetermined dynamic threshold, the training system provides indication, action and correlation weight set indictive of affinity between indication and action data.

In operation 312, the training system determines a result with regard to a satisfaction of at least on indications and action where none indexed indication or actions are invalidated and removed from the resultant data.

In operation 313, the training system provides to a central processor validated datasets including indications, actions, affinity and excluded data structed for training of a large-scale adventive filter selected from the list including artificial intelligence, machine learning, neural network, expert system and fuzzy logic.

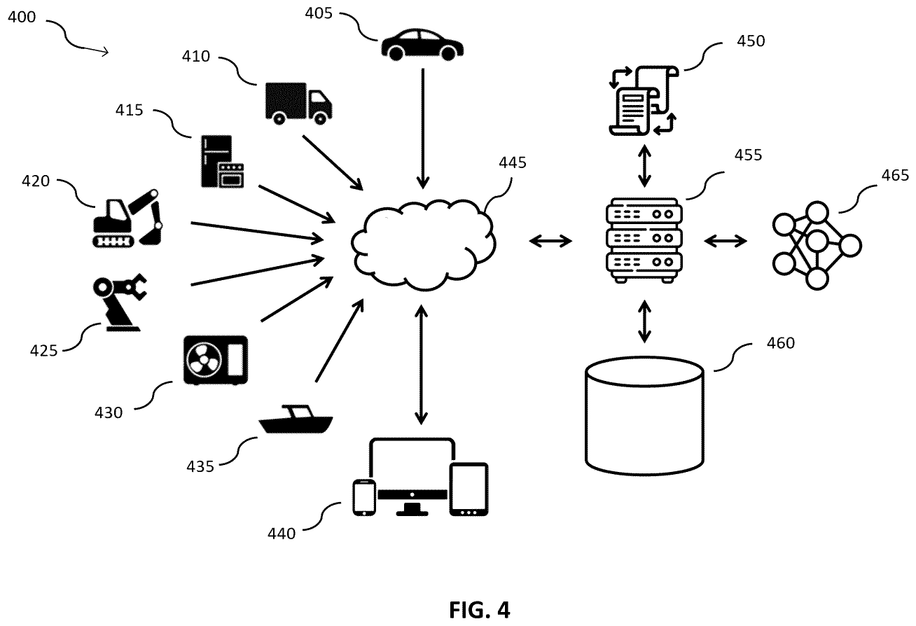

FIG. 4 illustrates an example computing device for use in the multi-dimensional creation of affinity linked training data with co-sampled data to be used as training and test data. Embodiments performing the affinity linking operations used to create affinity linked training data anticipates analysis of one or more operational system types illustrated in FIG. 4. The multi-dimensional creation 400 of affinity linked training data anticipates analysis of one or more operational system types including but not limited to automotive 405, long haul 410, appliance 415, heavy equipment 420, industrial 425, HVAC 430 and marine 435 applications. In some embodiments all the affinity linked training data gathered via the internet 445 are used to train an analysis system 455 comprising one or more computing devices, which maintains system type trained network descriptors in siloed affinity linked data training sets 450 for classification by one or more adaptive filters 465 based on one more or more applications held in memory 460, responsive to a user's request 440. While affinity linked data training sets 450 will be typically be siloed some cross correlation between common functions is anticipated and, in some cases, users requests 440 will enjoy training from more than one type of said training sets.

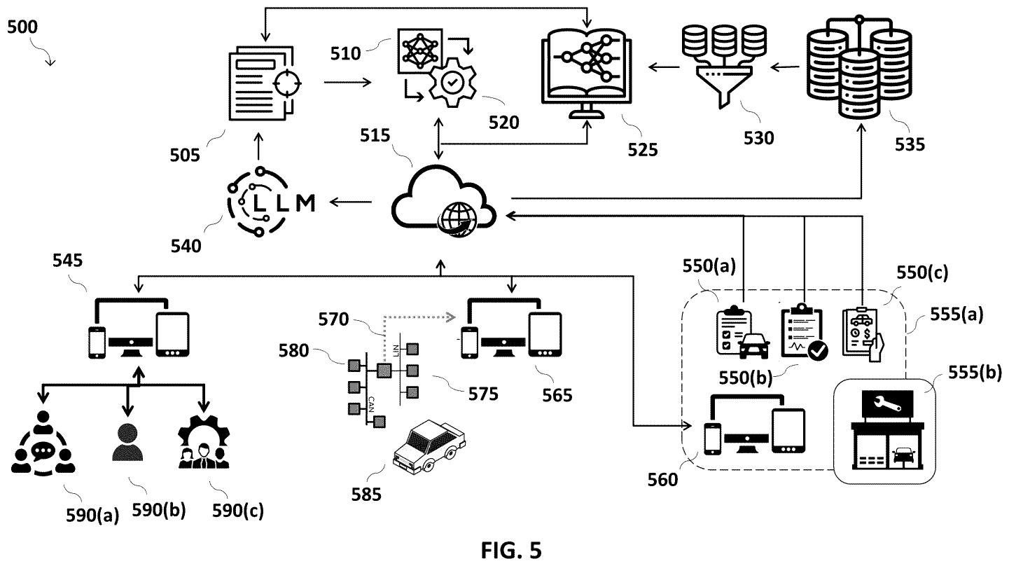

FIG. 5 illustrates a method 500 performed by a system for processing multi-dimensional data. In some examples, method 500 includes processing multi-dimensional data from one or more specialized facilities 555b dedicated to the maintenance, repair, and servicing of vehicles. The specialized facilities 555b may provide services encompassing mechanical repairs, addressing issues with the engine, transmission, brakes, and other mechanical components, as well as electrical repairs involving wiring, batteries, and starter motors. Specialized facilities 555b may alternately or additionally perform routine maintenance procedures such as oil changes, tire rotations, filter replacements, and brake inspections. Specialized facilities 555b may also offer tire services, exhaust and emission system repairs, and heating, ventilation, and air conditioning (HVAC) services.

Also illustrated in the method 500 illustrated in FIG. 5 is one or more specialized hardware and software systems 560 used to facilitate transactions with customers. These devices include a combination of hardware components like a computer or touchscreen monitor, cash drawers, barcode scanner, receipt printer, and often, a card payment terminal. These components work in conjunction with software to record the incoming record of vehicle issues, shop orders, parts ordering, diagnostics, customer information, documentation of issues found, worked performed, work recommended, parts used, labor hours spent, vehicle information, customer information, pricing and transaction data. These specialized hardware and software systems 560 additionally calculate the total cost of products or services, process payments, generate receipts, and often are used to update inventory records.

Illustrated in the method 500 of FIG. 5 is the repair shop process 555a which typically includes a consultation with a service advisor or technician who listens to the description of the problem and possibly performs a visual inspection. They will then provide an initial diagnosis of the issue along with an estimate of the cost and time needed for the repair provided to a customer as an estimate 550a. If the customer agrees to the terms, the repair process begins and a shop order 550b is created giving the technician the initial information and becomes a log for additional findings in the repair process. Depending on the complexity of the issue, it may require ordering replacement parts, which also will be logged in the shop order 550b or addendum of the shop order. Ultimately, the customer is presented with an invoice 550c, which may include, for example, a summary of repairs completed, and/or a cost of parts and labor. The repair shop process may alternately or additionally involve routine maintenance tasks like oil changes or tire rotations, and in some examples, the same information pattern is followed, including an estimate 550a, a shop order 550b with findings in the process of the service, and an invoice 550c.

In some examples, the method 500 of FIG. 5 further includes data gathering from a vehicle 585 under analysis where data representative of the vehicle's operation may be provided by at least one of two types of communication buses, specifically a Controller Area Network 580 and/or a Local Interconnect Network 575. In some examples, each of the Controller Area Network 580 and/or a Local Interconnect Network 575 facilitate the exchange of data between various electronic control units (ECUs) and devices. Each of the Controller Area Network 580 and/or a Local Interconnect Network 575 serves different purposes within the method 500.

In some examples, data gathered from the Controller Area Network 580 is collected and formatted for diagnostic analysis and training on real-time communications between various ECUs and sensors within the vehicle 585. In some examples, this analysis mirrors the data without interference, as in some examples, the data itself is critical and time sensitive. The temporal analysis of data against a common time allows for diagnostics of like engine control, transmission control, anti-lock braking systems (ABS), airbag deployment, and other functions not only against predefined thresholds but also through time, region, use and importantly across like makes models and configurations so that anomalies can be identified and classified. In some examples, when using the method 500 for cross-vehicle classification, the method 500 is facilitated by the training of robust, reliable, data in noisy vehicle environments noting that multiple ECUs may communicate simultaneously. This data is gathered transparently and timestamped by local hardware and software 565 for analysis 520 and training 525 by the system executing the method 500.

In some examples, data is also gathered from the Local Interconnect Network 575 at a lower speed of sampling and is formatted and transmitted to the classifier training 525 for diagnostic analysis and training 525 of an adaptive filter 510 for non-essential tasks that do not require real-time communication. In some examples, while data gathered from the Controller Area Network 580 requires local streaming and timestamps to represent the real-time nature of the data, the data collected from the Local Interconnect Network 575 tends to be state based, hence requiring significantly less formatting. In some examples, like the data gathered from the Controller Area Network 580, the data gathered from the Local Interconnect Network 575is similarly gathered transparently and timestamped by local hardware and software 565 for analysis 520 and training 525 by the system executing the method 500.

In some examples, data gathered from the vehicle networks 570 is loaded into memory 535 for subsequent filtering 530 and training 525 along with data gathered from user reports 590b, subject matter experts 590c providing expert training on like issues, stakeholder inputs 590a as well as data from gathered from local hardware and software 565 and specialized hardware and software systems 560 for source identification and correlation. In some examples, a plurality of distinct sets of prompts is generated based on a plurality of historical user queries and historical user commands. In some examples, this results in a distinct set of prompts including test sampling of a plurality of historical user queries and historical user commands from the one or more production logs. In some examples, a plurality of historical user queries and historical user commands from the one or more production logs are converted into the plurality of distinct sets of prompts for sourcing raw data. In some examples, local data information is required as local procedures can create format variations in the presentation of data for analysis so the network transfer of data for training via a communication network 515 may include a functional preprocessed payload of data for training. However, in some examples, normalization is performed as part of the data intake to instruct the module training 525.

Data gathered for training, such as data gathered from estimates550a, shop orders 550b, invoices 550c, vehicle networks 570, stakeholder inputs 590a, user reports 590b, and subject matter experts 590c, in many cases is presented in narrative form. As such, an artificial neural network 540 is trained using self-supervised learning and semi-supervised learning augmented with expert learnings 505 retrieved from the memory 535 of the electromechanical vector databases. This dynamic augmentation lets the diagnostic result overcome the limitations of static knowledge and generate responses that are expert informed, accurate, and contextually relevant.

FIG. 5 additionally illustrates how data indexed by vehicle identification numbers is gathered via communication network 515, said data being sourced from the repair shop process 555a. In some examples, the data specifically includes estimates 550a, shop orders 550b, and invoices 550c. In some examples, the data further includes data collected by devices from the memory 353 of electromechanical vector databases, such data from the vehicle networks 570 as well as relevant data relevant sourced from subject matter experts 590c, user reports 590b and stakeholder inputs 590a. In some examples, this data is selectively processed and undergoes filtering 530 for training of 525 of an adaptive filter 510 to derive completed analysis 520 in the form of classification of the repair diagnostic were said system uses a detailed system implementation using a data training method, such as the detailed system implementation of the application environment 200 described with reference to FIG. 2, using the training method 100, described with reference to FIG. 1.

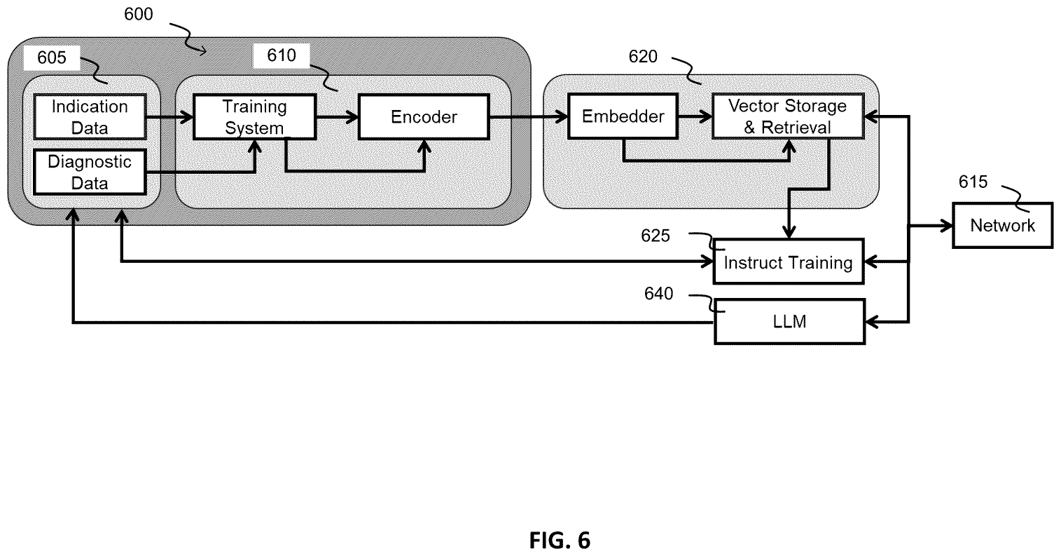

FIG. 6 illustrates an example training system 600. In some examples, the example training system performs a method that is substantially similar to the method 100 described with reference to FIG. 1. In some examples, the training system 600 includes self-supervised learnings and semi-supervised learnings augmented with indication data 605. In some examples, the indication data 605 includes the expert learnings 505 described with reference to FIG. 5. In some examples, the self-supervised learnings and semi-supervised learnings are inpainted via an LLM 640, such as, for example, the artificial neural network 540 described above with reference to FIG. 5. In some examples, the self-supervised learnings and semi-supervised learnings are used for instruct training 625, such as instruct training 525 described with reference to FIG. 5, of an adaptive filter 610, such as the adaptive filter 510 described with reference to FIG. 5. In some examples, encoded outputs of the adaptive filter 610 can then be iteratively classified to derive a completed analysis 620 of the repair diagnostic, such as the completed analysis 520 described with reference to FIG. 5, were said training system 600 gathers data and provides responses to the plurality of data sources and queries via communications network 615 such as the communication network 515 described with reference to FIG. 5. In some examples, the communication network 615 comprises a cloud-based communications network.

In some examples, the system interactively engages with users through responsive questions and integrates both quantitative and qualitative inputs, utilizing expert-level trainings and interrelations in data sets to augment the generation of diagnostic results and subsequently presents said diagnostic results to users in a manner that correlates identified problems with associated ordered probabilities.

In some examples, the system's responsive interface includes an adaptive filter which classifies relevant data to generate clarifying questions tailored to the specific analysis. Said relevant data can reference various parameters, including but not limited to, the vehicle's make, model, year, mileage, ZIP Code, and descriptors of any underlying problem. The disclosed system initiates user data-based diagnostics with an initial generic prompt. Based on the classification of a user's response to the generic prompt, the system generates sequential clarifying questions as prompts for the user. In some examples, the generation of sequential clarifying questions as prompts for the user is based on the user's prior responses, according to certain learned probabilistic rules predicated on prior training and user interaction throughout the diagnostic process.

In some examples, the system integrates both quantitative user inputs and qualitative expert learnings into the diagnostic process. This integration occurs not only during the initial training but continues through subsequent interactions. The system combines subjective perceptions of anomalies, such as noises, smells, and vibrations, with objective quantitative data such as mileage and diagnostic error codes. This approach fuses expert sourced training and deep device under analysis domain knowledge with sparce data input from the observed device under analysis to provide improved diagnostic results.

The diagnostic results are presented to the user in a manner that encapsulates both identified problems and their associated probabilities. In some examples, the system calculates the sum of all relevant problems to equal 100%, including potential unknown issues. In one preferred embodiment the output is presented in a Pareto chart. The flexibility in presentation ensures that users can comprehend the diagnostic results effectively while allowing for adaptability in visualization methods.

Generally, the computing devices disclosed herein can each include at least one central processing unit (“CPU”) and computer-readable data storage media including a system memory. The system memory includes a random access memory (“RAM”) and a read-only memory (“ROM”). The system memory stores software instructions and data. The system memory is connected to the CPU. The system memory provides non-volatile, non-transitory storage for each computing device. Computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by each computing device.

The computer-readable data storage media of each computing device can store software instructions and data, including an operating system suitable for controlling the computing device. The computer-readable data storage media also store software instructions and software applications that, when executed by the CPU, cause each computing device to provide the functionality discussed herein.

Reference throughout this disclosure to “an embodiment” or “the embodiment” means that a particular feature, structure, or characteristic described in connection with that embodiment is included in at least one embodiment. Thus, the quoted phrases, or variations thereof, as recited throughout this disclosure are not necessarily all referring to the same embodiment.

Similarly, it should be appreciated that in the above description of embodiments, various features are sometimes grouped together in a single embodiment, figure, or description thereof for the purpose of streamlining the disclosure. This disclosure includes all permutations of the independent claims with their dependent claims.

Recitation in the claims of the term “first” with respect to a feature or element does not necessarily imply the existence of a second or additional such feature or element or a particular order unless specified. It will be apparent to those having skill in the art that changes may be made to the details of the above-described embodiments without departing from the underlying principles of the disclosure.

While specific embodiments and applications of the present disclosure have been illustrated and described, it is to be understood that the disclosure is not limited to the precise configuration and components disclosed herein. Moreover, the present disclosure further contemplates methods of use and/or manufacture of any forearm sling described by this disclosure, which can include but is not limited to providing, installing, attaching, fitting, fabricating and/or configuring any portion of any forearm sling or accessory therefore as described anywhere in this disclosure. Various modifications, changes, and variations which will be apparent to those skilled in the art may be made in the arrangement, operation, and details of the methods and systems of the present disclosure disclosed herein without departing from the spirit and scope of the disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A diagnostic system, the system comprising:
one or more remote sources of machine learning training data;
one or more hardware computing devices implementing the diagnostic system that:
constructs a probabilistic affinity mapping between a first and a second dataset of the machine learning training data, which, when linked, comprises a plurality of historical queries and historical commands test-sampled from one or more production logs of a deployed dialogue system;
configures one or more training data sourcing parameters to source one of the first and second dataset of the machine learning training data from the one or more remote sources of the machine learning training data;
transmits the one or more training data sourcing parameters to the one or more remote sources of the machine learning training data;
collects the one of the first and second dataset of the machine learning training data;
calculates one or more validation metrics of the one of the first and second dataset of machine learning training data, including calculating one or more of a coverage metric value and a diversity metric value of the machine learning training data;
identifies whether to train at least one machine learning classifier based on one or more of the coverage metric value and the diversity metric value of the machine learning training data;
uses the machine learning training data as machine learning training input, to train the at least one machine learning classifier when the coverage metric value of the machine learning training data satisfies a minimum coverage metric value threshold; and
responsive to training the at least one machine learning classifier using the machine learning training data, deploys the at least one machine learning classifier to intake users' requests and provide relevant diagnostic analysis.

2. The system according to claim 1, wherein calculating the coverage metric value of the one of the first and second dataset of machine learning training data includes to:
calculate a distinct coverage metric value for each of a plurality of distinct affinity linked datasets within the machine learning training data, wherein the distinct coverage metric value relates to a measure indicating how well a distinct affinity linked dataset of the distinct affinity linked datasets covers a request expressed by a user; and
calculate an aggregated coverage metric value for the machine learning training data based on the distinct coverage metric values for each of the plurality of distinct affinity linked datasets.

3. The system according to claim 2, wherein calculating one or more validation metrics of the machine learning training data includes to:
calculate a probabilistic affinity metric value for each of a plurality of indication to action data representations and a plurality of action to indication data representations within the machine learning training data; and
calculate an aggregated diversity metric value for the machine learning training data based on the diversity metric value for each of the plurality of distinct affinity linked datasets within the machine learning training data;
wherein the diversity metric value relates to a level of heterogeneity among the machine learning training.

4. The system according to claim 2, wherein:
the machine learning training data is defined by a plurality of distinct predictive probabilities;
each of the plurality of distinct affinity linked datasets is associated with a distinct user request classification task of the deployed dialogue system; and
each of the plurality of distinct affinity linked datasets includes at least one training and test subset of a plurality of diagnostic commands obtained from apriori diagnostic classification training.

5. The system according to claim 1, wherein:
the diagnostic system further constructs each of the first and the second dataset of the machine learning training data using a plurality of engineered queries and engineered commands, each of the plurality of engineered queries and engineered commands being artificially generated for one or more identified intent classification tasks.

6. The system according to claim 5, wherein:
the diagnostic system further constructs a composition of the each of the first and the second dataset of the machine learning training data to include a first predetermined ratio of historical queries and historical commands and a second predetermined ratio of engineered queries and engineered commands, and
the first predetermined ratio of historical queries and historical commands has a value that is greater than the second predetermined ratio of engineered queries and/or engineered commands.

7. The system according to claim 1, wherein:
the machine learning training data comprises a plurality of distinct indications datasets, action datasets and affinity linked interaction datasets, each of the plurality of distinct indications datasets, action datasets and affinity linked interaction datasets used for convergence of a machine learning system.

8. The system according to claim 1, wherein configuring the one or more training data sourcing parameters includes:
generating a plurality of distinct sets of prompts for sourcing distinct indications datasets and action datasets for each of a plurality of objective classification tasks of the deployed dialogue system.

9. The system according to claim 8, wherein:
generating the plurality of distinct sets of prompts is based on the plurality of historical queries and historical commands; and
generating the plurality of distinct sets of prompts includes:
test sampling the plurality of historical queries and historical commands from the one or more production logs of the deployed dialogue system, and
converting the plurality of historical queries and historical commands into the plurality of distinct sets of prompts for sourcing raw machine learning training data.

10. A method, comprising:
constructing an affinity linked machine learning training dataset comprising a plurality of historical queries and historical commands test sampled from one or more production logs of a deployed diagnostic system;
configuring one or more training data sourcing parameters to source the affinity linked machine learning training dataset from one or more remote sources of indication and action data;
transmitting the one or more training data sourcing parameters to one or more remote sources of machine learning training data and collecting the affinity linked machine learning training dataset;
calculating one or more validation metrics of the affinity linked machine learning training dataset, wherein calculating the one or more validation metrics includes calculating one or more of a coverage metric value and a diversity metric value of the affinity linked machine learning training dataset;
identifying whether to train at least one machine learning classifier of the artificially intelligent diagnostic system based on one or more of the coverage metric value and the diversity metric value of the affinity linked machine learning training dataset;
using the affinity linked machine learning training dataset to train the at least one machine learning classifier if the coverage metric value satisfies a minimum coverage metric threshold; and
responsive to training the at least one machine learning classifier, deploying the at least one machine learning classifier into an online implementation of an artificially intelligent diagnostic system.

11. The method of claim 10, wherein the coverage metric value relates to a measure indicating how well the affinity linked machine learning training dataset covers an intent expressed by a user of the artificially intelligent diagnostic system.

12. A method of creating affinity linked training data, the method comprising:
capturing data comprising one or more data or image files to provide a delimited dataset;
extracting one or more contextual tags from the one or more data or image files of the delimited dataset;
indexing the one or more data or image files of the delimited dataset by the one or more contextual tags;
partitioning the one or more data or image files of the delimited dataset into ingress data and egress data;
performing action recognition processing on the egress data;
performing indication recognition processing on the ingress data;
generating a first data structure and second data structure of interleaved data; and
unifying the first data structure and the second data structure into a training set for one or more processing models.

13. The method of claim 12, wherein performing action recognition processing on the egress data comprises:
structuring the egress data for action recognition processing;
performing automated action recognition; and
performing action to indication adaptation processing.

14. The method of claim 12, wherein performing indication recognition processing on the ingress data comprises:
structuring the ingress data for indication recognition processing;
performing automated indication recognition processing; and
performing indication to action adaptation processing.

15. The method of claim 12, wherein the one or more data or image files comprise one or more of data gathered from vehicle estimates, vehicle shop orders, vehicle repair invoices, vehicle networks, vehicle user reports, and vehicle subject matter experts.

16. The method of claim 12, wherein the one or more contextual tags comprise vehicle identification numbers.

17. The method of claim 12, wherein capturing data comprising one or more data or image files to provide a delimited dataset includes communication of the data over a controller area network and/or a local interconnect network.

18. The method of claim 12, wherein the one or more contextual tags include information comprising: personal information, vehicle shop information, vehicle service issues, vehicle OBDII codes, vehicle service reports, vehicle diagnosis, vehicle service, vehicle labor, vehicle parts, vehicle pricing, vehicle warranties, or vehicle conditions.

19. The method of claim 12, wherein indexing one or more data or image files of the delimited dataset by the one or more contextual tags includes using a recursive framework assigning template index indicators to the data or image files.

20. The method of claim 12, wherein action recognition processing on the egress data and indication recognition processing on the ingress data are performed as parallel processes.
